(19) United States
(12) Patent Application Publication
(10) Pub. No.: US 2017/0368553 A1
(43) Pub. Date: Dec. 28, 2017

(54) METHOD AND APPARATUS FOR SEPARATING LIGHTWEIGHT MATERIALS FROM FABRIC PIECES

(71) Applicant: PSIL Holdings, LLC, Tulsa, OK (US)

(72) Inventors: Kayren Joy Nunn, Bixby, OK (US); Susan Hughes Brown, Bixby, OK (US); Steven Jacob Brown, Bixby, OK (US)

(21) Appl. No.: 14/672,142

(22) Filed: Mar. 28, 2015

(51) Int. Cl. B02C 17/18; B02C 17/04; B02C 17/16; D01G 11/04

(52) U.S. Cl. CPC B02C 17/1865; D01G 11/04; B02C 17/1875; B02C 17/04; B02C 17/184; B02C 17/163; B02C 2201/00

(57) ABSTRACT

The present invention discloses a method and corresponding apparatus for separating lightweight materials from fabric pieces. The method comprises the steps of (a) introducing fabric pieces into a tumbling means having perforations for lightweight materials in the fabric pieces to be removed therethrough and coupled to a first source of negative pressure; (b) tumbling the fabric pieces in the tumbling means and simultaneously applying negative pressure from the first source of negative pressure to the tumbling means for removing lightweight particles detached from the tumbling fabric pieces from the tumbling means; (c) transporting the fabric pieces from the tumbling means to a top of a vertical separation chamber; and (d) applying forced air to the fabric pieces as the fabric pieces drop from the top to bottom of the vertical separation chamber by gravity for separating the lightweight materials from the fabric pieces, and simultaneously applying negative pressure from a second source of negative pressure to the vertical separation chamber to remove the lightweight materials separated from the fabric pieces from the vertical separation chamber; repeating this step until the fabric pieces are substantially cleared of any lightweight materials. The apparatus comprises a tumbling means and a vertical separation chamber.

### BACKGROUND

The present invention is generally in the field of equipment to support the “Method and System of Processing Waste Fabrics to Rejuvenate Fibrous Materials” for the recycling of post industrial and pre consumer materials. In particular, the field of this invention relates to a method and apparatus for separating lightweight materials from fabric pieces.

### SUMMARY

In a fabric cutting operation, debris results from the use of pattern markers, pattern paper made from pulp, plastic or other materials. These materials cling to the fabric pieces or become entrapped in the folds of the fabric pieces as they are processed and disposed of. In traditional recycling, the debris is typically processed with the fabric pieces and becomes part of the overall end product. However, in the rejuvenation of quality, higher value endproducts designed to compete with virgin materials, this debris cannot exist for obvious quality control reasons.

Therefore, during the process of recycling waste fabric materials, there is a need to extract lightweight materials such as debris, paper, plastic, markers, dust and so forth from the waste fabric materials before they are further processed. Such lightweight materials not only may damage the equipments for processing the waste fabric materials, but also pose negative impact on the quality of the end-products. The lightweight materials may be extracted from the waste fabric pieces by hand sorting; however, hand sorting not only creates a cost barrier, but also makes it difficult to deliver a microbial-free product given the human hand interaction with the materials. A number of different solutions have been presented to the textile industry over the years to solve this problem, but some have solved only a portion. However, none of the proposed solutions could eliminate physical manipulation of the product. The removal of lightweight materials such as paper and plastic; markers from cutter rooms; as well as strings and threads which become buried in the fabric folds, became problematic due to the overwhelming volume of fabric in the process. The eradication of heavier debris, metals and plastics has been efficiently addressed in the textile industry, with only the lightweight materials still requiring a solution.

### BRIEF DESCRIPTION OF THE DRAWINGS

FIG. 1 illustrates a side view of an embodiment of the Tumbling Means.

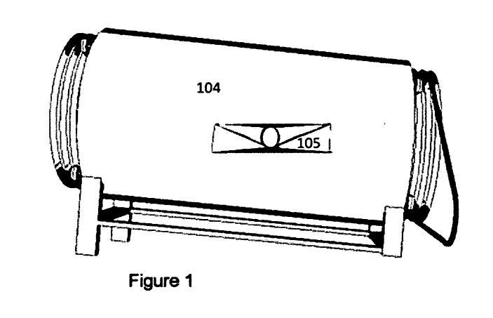

FIG. 2 illustrates a front view of an embodiment of the Tumbling Means.

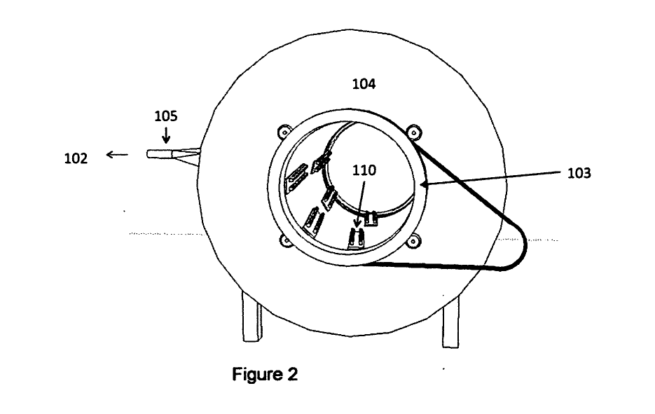

FIG. 3 illustrates a view of an embodiment of the Vertical Separation Chamber.

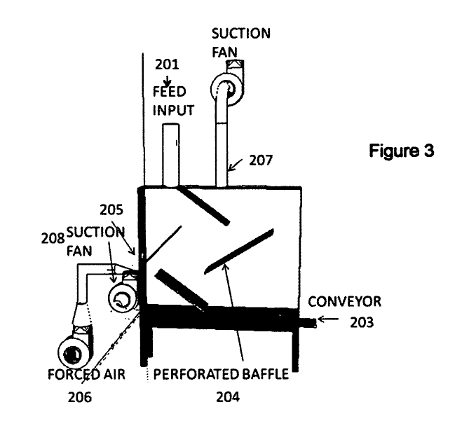

FIG. 4 illustrates a view of an embodiment of the Apparatus for Separating Lightweight Materials From Fabric Pieces.

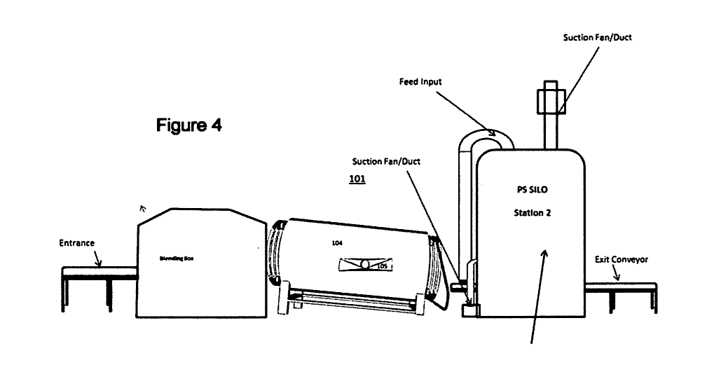

### DETAILED DESCRIPTION

It is an object of the present invention to provide a method and apparatus for separating lightweight materials such as plastic, paper, markers, threads, strings, dust and the like from fabric pieces which include but not limited to cotton or cotton blends, linen, ramie, jute, or other fabric made from natural fibers.

It is another object of the present invention to provide a method and apparatus for separating lightweight materials from nylon, lycra, polyester or silk where there exists an abundance of static associated with the movement of the materials.

To attain this, the present invention provides a method for separating lightweight materials from fabric pieces, comprising the steps of:

(a) introducing fabric pieces into a tumbling means having perforations for lightweight materials in the fabric pieces to be removed therethrough and coupled to a first source of negative pressure;

(b) tumbling the fabric pieces in the tumbling means and simultaneously applying negative pressure from the first source of negative pressure to the tumbling means for removing lightweight particles detached from the tumbling fabric pieces from the tumbling means;

(c) transporting the fabric pieces from the tumbling means to a top of a vertical separation chamber;

(d) applying forced air to the fabric pieces as the fabric pieces drop from the top to bottom of the vertical separation chamber by gravity for separating the lightweight materials from the fabric pieces and simultaneously applying negative pressure from a second source of negative pressure to the vertical separation chamber to remove the lightweight materials separated from the fabric pieces from the vertical separation chamber, repeating this step until the fabric pieces are substantially cleared of any lightweight materials.

The fabric pieces are preferably sized to about 6-14 inches long or 6-14 inches square before introducing into the tumbling means in Step (a).

As the fabric pieces are tumbled in the tumbling means in Step (a), the fabric pieces are opened by hard and short protrusions provided in an interior surface of the tumbling means.

In Step (d) the fabric pieces drops in the vertical separation chamber in a zigzag manner.

The present invention also provides an apparatus for separating lightweight materials from fabric pieces, comprising:

a tumbling means having perforations for lightweight materials in the fabric pieces to be removed therethrough and coupled to a first source of negative pressure;

a vertical separation chamber which comprises an inlet at a top end thereof for connecting to the tumbling means via a transporting means, a fabric pieces conveyor at a bottom end thereof for connecting to an outlet for removing fabric pieces out of the vertical separation chamber, a plurality of perforated baffles arranged to direct the fabric pieces to move downward from the inlet to the outlet, a plurality of forced air inlet coupled to a forced air source for applying forced air to the fabric pieces as the fabric pieces drop in the vertical separation chamber by gravity, and a plurality of negative pressure ports coupled to a second source of negative pressure for applying negative pressure to the vertical separation chamber for removing lightweight materials separated from the fabric pieces.

As illustrated in the accompanying figures, the present invention provides an apparatus for separating lightweight materials from fabric pieces, comprising a tumbling means 101 and a vertical separation chamber 102. The lightweight materials to be removed include plastic particles, paper, markers, threads, strings, dust and other small debris. The fabric pieces include cotton, cotton blends, linen, ramie, jute and fabrics made from natural fibers.

The tumbling means 101 has perforations for lightweight materials in the fabric pieces to be removed therethrough and is coupled to a first source of negative pressure 102. The tumbling means 1 comprises a rotating cylinder 103 encased in an industrial coated steel external device 104. A large suction nozzle 105 is positioned on the outside of the external device 104 to remove the lightweight materials captured in the external device 104. Due to the constant low-grade vacuum provided by the first source of negative pressure 102, the rotating cylinder 103 as well as the external device 104 is airtight. The first source of negative pressure 102 is set to pull pressure of 0.5″ to 5″ depending on the amount of production designated for the apparatus. The external device 104 is equipped with a common collection space 106 to receive dust, lightweight particles, thread, strings, debris and other impurities that are filtered from the air. Air displacement is induced by a blower 107 located on the intake side which communicates with the external device 104 where a discharge passage 108 is positioned, which filters solid airborne impurities by a filtering means 109. The blower 107 is motor driven from a belt drive, but could be gear driven as well. Solid impurities from the common collection space 106 are collected in a small baling system outside the main production area and air is then evacuated from the system through a filter house to eliminate contamination originating from the facility.

The rotating cylinder 103 is made of steel in this embodiment and is provided with perforations 102 from 1/16″ to ⅜″ in diameter. These perforations 102 are sized to meet the specifications of the fabrics that are being processed. Inside the rotating cylinder 103 are a series of removable slats 110 that are designed to first move the fabric pieces from an input end of the rotating cylinder 103 through an output end of the rotating cylinder 103; and second, to cause the fabric pieces to be unfolded while they are tumbled through the rotating cylinder 103.

The opening slats 110 are angled with respect to a travel axis along which the fabric pieces travel in the rotating cylinder 103 so proper motion is created. The opening slats 11 are arranged in at least one, and preferably two or more rows with each of the rows positioned approximately 0.39 meters apart, and the rows are ideally offset in order to facilitate the fabric pieces to travel through the rotating cylinder 103. For example, in a 1.5 meters diameter cylinder which is 6 meters long, there would be sixteen opening slats 110, arranged in two rows of eight opening slats 110. The opening slats 110 are removable and can be made of flat metal pins, rubber, sections of 1 inch pins, flat metal bars, teflon, hard plastic or other combinations depending on the fabrics that are being opened.

The rotating cylinder 103 is installed on a stand 111 at a (−4 m) to (−6 m) slope to assist in the overall delivery of the fabric pieces. The action of the rotating cylinder 103 is one of tumbling and continuous rotation and resembles that of a dryer with the fabric pieces being tumbled as they move through the rotating cylinder 103. During the tumbling process, the fabric materials are opened as they make contact with the opening slats 110, thereby releasing the lightweight materials such as threads and debris. A perpetual vacuum encompasses the perforated cylinder 103 which suctions the lightweight materials as the fabric pieces transition through the rotating cylinder 103. Due to the cylindrical rotation, fabric pieces have begun to unfold and break apart from one another. As fabric pieces are unfolded or “opened” during this stage, threads or strings that typically become caught in the folds or layers of the fabric pieces are released and removed from the process through the perforated cylinder 103 by the first source of negative pressure 102. Dust from the cutting process, as well as a large percentage of other small debris, exit the system at this stage as well. This aspect of the process is critical to the overall quality of the downstream fiber and is a safeguard to end-product cost efficiency. For example, one group of colored fibers in a batch of white medical grade cotton non-woven can create off-spec material for a downstream product that could result in a costly consumer product recall.

The rotating cylinder 103 is preferably PLC controlled with a variable speed drive which makes changes easier when different speeds are required.

The vertical separation chamber 2 is connected to the tumbling means 1 via a transporting means 3. In this embodiment, the transporting means 3 is a feed chute which transports the fabric pieces from the output end of the tumbling means 1 to the inlet 201 at the top end of the vertical separation chamber 2 by suction.

The vertical separation chamber 2 is a tall, slender chamber and is built of coated steel. The overall scale of the vertical separation chamber 2 is 0.60 meters to 0.91 meters in depth, 4.5 meters to 5.5 meters in height, and 3.6 meters to 4.6 meters in width, with all specifications being relative to its production capacity. The vertical separation chamber 2 comprises an inlet 201 at a top end thereof for connecting to the tumbling means 1 via the transporting means 3, an electronic fabric pieces conveyor 202 at a bottom end thereof for connecting to an outlet 203 for removing fabric pieces out of the vertical separation chamber 2, a plurality of perforated baffles 204 arranged to direct the fabric pieces to move downward from the inlet 201 to the outlet 203, a plurality of forced air inlet 205 coupled to a forced air source 206 for applying forced air to the fabric pieces as the fabric pieces drop in the vertical separation chamber 2 by gravity, and a plurality of negative pressure ports 207 coupled to a second source of negative pressure 208 for applying negative pressure to the vertical separation chamber 2 for removing lightweight materials separated from the fabric pieces. The perforated baffles 204 are arranged in a manner to direct the fabric pieces to move downwards from the inlet 201 to the outlet 203 in a zigzag manner. The vertical separation chamber 2 has two negative pressure ports 207, one of which is positioned at the top end of the vertical separation chamber 2 and the other one of which is positioned at the bottom part of the vertical separation chamber 2. The second source of negative pressure 208 takes the form of two suction fans disposed at the two negative pressure ports 27 respectively.

After the fabric pieces enter the top end of the vertical separation chamber 2, they are delivered by gravity through the inlet 201. As the heavy fabric pieces drop onto the first perforated baffle 204a, a blast of forced air enters the vertical separation chamber 2 via the first forced air inlet 205a at a 42 to 60 degree angle which blows the fabric pieces apart and creates a separation of the heavy materials (the fabric pieces) from the lightweight materials (the paper and plastic) that have remained with the fabric pieces to this point. The separated debris are then taken through the negative pressure port 207 at the top of the vertical separation chamber 2.

The fabric pieces are then transported by another blast of air from the second forced air inlet 205b onto the second perforated baffle 204b at the center of the vertical separation chamber 2. The fabric pieces continue to move by air or forced manipulation through the vertical separation chamber 2 until they has been removed from the vertical separation chamber 2. The constant movement and natural gravitational pull within the vertical separation chamber 2 creates an action in which the fabric pieces, which weigh more than the debris, fall to the fabric pieces conveyor 202 at the bottom of the vertical separation chamber 2. Thus the lightweight paper, plastic, markers and remaining dust and debris then exit the vertical separation chamber 2 at two designated negative pressure ports 27 which have been created by the sheer volume of air and immense use of negative pressure as well as the physical design of the vertical separation chamber 2 itself. The vertical separation chamber 2 is designed with a height such that lightweight materials are provided adequate space to rise above the fabric pieces in order to be suctioned from the vertical separation chamber 2. The narrow width of the vertical separation chamber 2 allows for proper suction to be controlled allowing only the paper, plastic and other debris to be removed from the vertical separation chamber 2, not the fabric pieces.

The vertical separation chamber 2 is driven by the amount of air necessary to meet the overall production requirements of the line. In the case of a vertical separation chamber 2 running 2,500 pounds per hour, the amount of air required is approximately 12 to 15 K CFM. Other vertical separation chambers, however, are sized according to their respective production requirements. The purpose of the vertical separation chamber 2 is to complete the process of thread, dust and debris removal, but its concentration is on the elimination of pattern paper, plastic, and pattern markers that come from cutting rooms during the pattern cutting operation.

While both the tumbling means 1 and the vertical separation chamber 2 are not required, they are preferred with some of fabrics or fibers. In some operations, one or the other can be utilized. In the embodiment herein described, it is assumed that smaller debris, threads, strings, dust, etc. have been extracted in the tumbling means 1. The utilization of the tumbling means 1 creates an unfolding of the fabrics which permits the vertical separation chamber 2 to extract even larger components of debris, which would otherwise become problematic in the preparation of these fabric pieces for quality downstream production.

By means of the above mentioned apparatus, the present invention also provides the present invention provides a method for separating lightweight materials from fabric pieces, comprising the steps of:

(a) introducing fabric pieces into a tumbling means having perforations for lightweight materials in the fabric pieces to be removed therethrough and coupled to a first source of negative pressure;

(b) tumbling the fabric pieces in the tumbling means and simultaneously applying negative pressure from the first source of negative pressure to the tumbling means for removing lightweight particles detached from the tumbling fabric pieces from the tumbling means;

(c) transporting the fabric pieces from the tumbling means to a top of a vertical separation chamber;

(d) applying forced air to the fabric pieces as the fabric pieces drop from the top to bottom of the vertical separation chamber by gravity for separating the lightweight materials from the fabric pieces and simultaneously applying negative pressure from a second source of negative pressure to the vertical separation chamber to remove the lightweight materials separated from the fabric pieces from the vertical separation chamber, repeating this step until the fabric pieces are substantially cleared of any lightweight materials.

In particular, the fabric pieces are preferably sized to about 6-14 inches long or 6-14 inches square before introducing into the tumbling means in Step (a). As the fabric pieces are tumbled in the tumbling means in Step (a), the fabric pieces are opened by hard and short protrusions provided in an interior surface of the tumbling means. In Step (d) the fabric pieces drops in the vertical separation chamber in a zigzag manner.

According to the above disclosure, a person skilled in the art may make suitable modifications and changes to the above embodiments. Therefore, the present invention is not limited by the above disclosure and the embodiment described. Modifications and changes to the present invention should fall within the scope of the present invention as defined by the claims. Besides, although certain technical terms have been used throughout the specification, the technical terms are intended for ease of explanation and are not intended to restrict the present invention in any ways.

1. A method for separating lightweight materials from fabric pieces, comprising:
(a) introducing fabric pieces into a tumbling means having perforations for lightweight materials in the fabric pieces to be removed therethrough and coupled to a first source of negative pressure;
(b) tumbling the fabric pieces in the tumbling means and simultaneously applying negative pressure from the first source of negative pressure to the tumbling means for removing lightweight particles detached from the tumbling fabric pieces from the tumbling means;
(c) transporting the fabric pieces from the tumbling means to a top of a vertical separation chamber;
(d) applying forced air to the fabric pieces as the fabric pieces drop from the top to bottom of the vertical separation chamber by gravity for separating the lightweight materials from the fabric pieces, and simultaneously applying negative pressure from a second source of negative pressure to the vertical separation chamber to remove the lightweight materials separated from the fabric pieces from the vertical separation chamber; repeating this step until the fabric pieces are substantially cleared of any lightweight materials.

2. The method of claim 1, wherein the fabric pieces are preferably sized to about 6-14 inches long or 6-14 inches square before introducing into the tumbling means in Step (a).

3. The method of claim 1, wherein as the fabric pieces are tumbled in the tumbling means in Step (a), the fabric pieces are opened by hard and short protrusions provided in an interior surface of the tumbling means.

4. The method of claim 1, wherein in Step (d) the fabric pieces drops in the vertical separation chamber in a zigzag manner.

5. An apparatus for separating lightweight materials from fabric pieces, comprising:
a tumbling means having perforations for lightweight materials in the fabric pieces to be removed therethrough and coupled to a first source of negative pressure;
a vertical separation chamber which comprises an inlet at a top end thereof for connecting to the tumbling means via a transporting means, a fabric pieces conveyor at a bottom end thereof for connecting to an outlet for removing fabric pieces out of the vertical separation chamber, a plurality of perforated baffles arranged to direct the fabric pieces to move downward from the inlet to the outlet, a plurality of forced air inlet coupled to a forced air source for applying forced air to the fabric pieces as the fabric pieces drop in the vertical separation chamber by gravity, and a plurality of negative pressure ports coupled to a second source of negative pressure for applying negative pressure to the vertical separation chamber for removing lightweight materials separated from the fabric pieces.

6. The apparatus of claim 5, wherein the tumbling means comprises a rotating cylinder encased in an external device; the external device is coupled to the first source of negative pressure and the rotating cylinder communicates with the external device via a suction nozzle.

7. The apparatus of claim 6, wherein the rotating cylinder has an interior surface disposed with a plurality of rows of opening slats which are angled with a travel axis along which the fabric pieces travel in the tumbling means, and the rows are offset from each other.

8. The apparatus of claim 7, wherein the rotating cylinder is installed on a stand at a negative slope.

9. The apparatus of claim 6, wherein the rotating cylinder has perforations which are sized up to ⅜ inch each.

10. The apparatus of claim 7, wherein the opening slats are made of metal pins, rubber, sections of 1 inch pins, flat metal bars, Teflon, hard plastic or a combination thereof.

11. The apparatus of claim 7, wherein the opening slats removably disposed on the interior surface of the rotating cylinder.

12. The apparatus of claim 5, wherein the perforated baffles are arranged in a manner to direct the fabric pieces to move downwards from the inlet to the outlet in a zigzag manner.

13. The apparatus of claim 5, wherein the vertical separation chamber has two negative pressure ports, one of which is positioned at the top end of the vertical separation chamber and the other one of which is positioned at the bottom end of the vertical separation chamber.

14. The apparatus of claim 13, wherein the second source of negative pressure takes the form of two suction fans disposed at the two negative pressure ports respectively.

15. The apparatus of claim 5, wherein the vertical separation chamber has a height which provides adequate space for the lightweight materials to rise above the fabric pieces in order to be suctioned from the vertical separation chamber.

16. The apparatus of claim 5, wherein the lightweight materials to be removed include plastic particles, paper, markers, threads, strings, dust and other small debris.

17. The apparatus of claim 5, wherein the fabric pieces include cotton, cotton blends, linen, ramie, jute and fabrics made from natural fibers.
